(19) United States
(12) Patent Application Publication
(10) Pub. No.: US 2024/0210876 A1
(43) Pub. Date: Jun. 27, 2024

(54) OUTER ROTOR TYPE MOTOR COVERED WITH COVER MEMBER AND IMAGE FORMING APPARATUS

(71) Applicant: CANON KABUSHIKI KAISHA, Tokyo (JP)

(72) Inventors: YUUMA HADA, Shizuoka (JP); ATSUSHI OGUNI, Kanagawa (JP)

(21) Appl. No.: 18/541,129

(22) Filed: Dec. 15, 2023

(30) Foreign Application Priority Data
Dec. 22, 2022 (JP) 2022-205341
Oct. 17, 2023 (JP) 2023-178621

(51) Int. Cl. G03G 21/20; G03G 15/00; H02K 5/20; H02K 21/22

(52) U.S. Cl. CPC G03G 21/206; G03G 15/757; H02K 5/207; H02K 21/22; H02K 2205/09

(57) ABSTRACT

An outer rotor type motor includes a motor substrate, a stator provided on the motor substrate, a rotor mounted with a rotational shaft, and a cover provided on an outside of the rotor in a radial direction of the rotor and an axial direction of a rotational shaft. The cover covers the motor. A first opening is formed on a central portion, in the radial direction, of a first portion of the cover opposing a part on which the rotational shaft of the rotor is mounted in the axial direction. An air is sucked inside of the cover from an outside of the cover through the first opening by rotation of the rotor, and the air sucked is discharged to the outside of the cover through a second opening formed on a position away from the first opening in the axial direction.

### FIELD OF THE INVENTION AND RELATED ART

The present invention relates to an outer rotor type motor covered with a cover member and an image forming apparatus in which this motor is installed.

Recently, an image forming apparatus is required to be downsized and to speed up its operation at the same time. As speeding up operation, a motor is required to increase output power. Also, the motor is sometimes incorporated inside the frame of the image forming apparatus for downsizing. When the motor is incorporated inside the frame of the main body of the image forming apparatus, the heat generated by the motor is easily accumulated and then the temperature of the motor rises. Further, sometimes a protecting member (hereinafter, referred to as a motor cover) is needed to protect the motor as a rotatable member. In that case, the heat accumulation is promoted and the temperature of the motor rises even more.

When the temperature of the motor rises, an efficiency of the motor decreases and a required torque is not be able to generate enough. As a means for cooling down the motor, the following are suggested. For example, reducing required output power of the motor, extending the output limit by increasing the size of the motor to output power even if the temperature rises, not loading on an element, decreasing the power consumption, cooling down a fan and so on. Also, for example, improving radiation of the heat with fins of the motor. (Referred as Japanese Laid-Open Patent Application No. 2014-155291)

Since the image forming apparatus is thoroughly required to downsize and lower cost, there is a problem that increasing the size of the motor greatly affects the size of the main body and makes the motor itself cost more. Also, when the air blows from a fan which cools down such as electric components, an enough effect of cooling is not obtained in many cases because the fan is far from the motor. Then, if a fan used only for cooling the motor is added, the size of the main body is increased and cost more. Also, if fins are provided with the motor, they take up more space.

### SUMMARY OF THE INVENTION

The present invention is developed in the situation described above. The object of this invention is to cool down the motor with a simple structure.

To solve the problem as described above, the present invention provides as follows: an outer rotor type motor covered with a cover member, the motor comprising: a motor substrate; a stator portion provided on the motor substrate; a rotor portion mounted with a rotational shaft and configured to rotate about the stator portion; and a cover member provided on an outside of the rotor portion with respect to a radial direction of the rotor portion and an axial direction of the rotational shaft and arranged to be fixed, wherein a first opening portion is formed on a central portion, in the radial direction, of a first portion of the cover member opposing a part on which the rotational shaft of the rotor portion is mounted in the axial direction. and wherein an air is sucked inside of the cover member from an outside of the cover member through the first opening portion by rotation of the rotor portion, and the air sucked is discharged to the outside of the cover member through a second opening portion formed on a position away from the first opening portion in the axial direction.

Further features of the present invention will become apparent from the following description of exemplary embodiments with reference to the attached drawings.

### BRIEF DESCRIPTION OF THE DRAWINGS

Part (a) and part (b) of FIG. 1 are perspective views of a motor and a cover in an embodiment 1.

Part (a) and part (b) of FIG. 2 are cross-sectional views showing presence or absence of the cover and the vicinity of the motor in the embodiment 1.

Part (a) and part (b) of FIG. 3 are cross-sectional views explaining presence or absence of the cover and a flow of air in the vicinity of the motor in the embodiment 1.

Part (a) and part (b) of FIG. 4 are schematic views showing a structure of an image forming apparatus in an embodiment 2.

FIG. 5 is a schematic view showing a flow of air in the image forming apparatus in the embodiment 2.

Part (a) of FIG. 6 is a cross-sectional view of the vicinity of the motor and part (b) of FIG. 6 is a cross-sectional view of the motor explaining the flow of air in the embodiment 2.

FIG. 7 is a perspective exploded view of a motor substrate and a motor sheet metal in the embodiment 2.

Part (a) of FIG. 8 is a cross-sectional view of a motor substrate and a motor metal sheet. Part (b) of FIG. 8 is a cross-sectional view of a motor substrate and a motor metal sheet explaining the flow of air in the embodiment 2.

Part (a) and part (b) of FIG. 9 are perspective and exploded views of a vicinity of the motor in an embodiment 3.

Part (a) of FIG. 10 is a cross-sectional view of a motor substrate and a motor metal sheet. Part (b) of FIG. 10 is a cross-sectional view of a motor substrate and a motor metal sheet explaining the flow of air in the embodiment 3.

Part (a) and part (b) of FIG. 11 explains a structure in an embodiment 4.

FIG. 12 explains the structure in the embodiment 4.

Part (a) and part (b) of FIG. 13 explains the structure in the embodiment 4.

FIG. 14 is explaining the structure in the embodiment 4.

### DESCRIPTION OF THE EMBODIMENTS

Embodiments to implement a present invention will be described in detail in examples with referring to the drawings as below.

### Embodiment 1

### Motor

A motor cover with cooling function (hereinafter, referred simply as a cover) 10 and an outer rotor type motor (hereinafter, referred simply as a motor) 50 in embodiment 1 will be described with FIGS. 1, 2, and 3. Members with the same numbers are referred to the same members in other figures.

FIG. 1(a) is a perspective view of the motor 50 covered with the cover 10 seen from the front side and FIG. 1(b) is a perspective exploded view of the motor 50 seen from the back side. FIG. 2(a) is a cross-sectional view of the cover 10 (the motor 50 is not a cross-section) and FIG. 2(b) is a side view of the motor 50. FIG. 3(a) shows a flow of air (an arrow with a dot-dash line) when the cover 10 is present and FIG. 3(b) is showing the flow of air when the cover 10 is absent. Also, in FIGS. 3(a) and 3(b), the drawing above is a top side view seen in a direction of a rotational shaft 400 and the drawing below is a cross-sectional view seen in a direction that is orthogonal to the rotational shaft 400.

The motor 50 includes the rotational shaft 400, a stater portion (not showing in the drawings) and a rotor portion 500. The stater portion is provided inside of the rotor portion 500. The cover 10 as a cover member covers over the rotor portion 500 of the motor 50. The cover 10 includes a suction opening portion 100 as a first opening portion opens as including an imaginary line L that is extended from the rotational shaft 400 in the motor 50 and includes a first portion 10a that crosses at a right angle to a rotational axis direction of the motor 50. Also, the cover 10 includes a second portion 10b as continuing with the first portion 10a and parallel to the rotational axis direction.

The cover 10 is provided around the rotor portion 500 to make a gap 300 between the cover 10 and the rotor portion 500. In more detail, the gap 300 is formed in both between the first portion 10a and rotor portion 500 and between the second portion 10b and the rotor portion 500 in the condition as the cover 10 covers the motor 50 (FIG. 2(a)). A suction opening portion 100 is provided in the cover 10 and on an extension of the rotational shaft 400 of the motor 50. Also, by covering the rotor portion 500 with the cover 10, an exhaust opening portion 200 is formed in between the motor 50 and the cover 10 on the opposite side of the suction opening portion 100. In other words, the exhaust opening portion 200 as a second opening portion that is continuously open through the gap 300 is formed on the opposite side of the suction opening in the rotational axis direction. The exhaust opening portion 200 is formed to be a ring shape when it is seen from the back side (the side of the rotational shaft 400).

Note that, though the suction opening portion 100 is a round shape, it is not limited to this, but other shapes may be possible. Also, though the first portion 10a is a round shape and the second portion 10b is a ring shape, it is not limited to this, other shapes may be possible if the gap 300 and the exhaust opening portion are formed in between the rotor portion 500 and the cover 10. Further, the suction opening 10a is located in the center in the radial direction of the first portion 10a of the cover 10 that is facing with a portion where the rotational shaft 400 is installed in the rotor portion 500 in the direction of the rotational shaft 400. Then, an area of the suction opening portion 100 is preferred to be 5% and more or 50% and less of an area of the rotor portion 500 when it is seen in an axial direction of the rotational shaft 400.

### Action

A flow of air as following is generated when the rotor portion 500 of the motor 50 attached with the cover 10 rotates in a direction of an arrow with a solid line in FIG. 3(a). Air is sucked inside the gap 300 through the suction opening portion 100 (herein after, referred as suction). The air sucked through the suction opening portion 100 flows in the gap 300 along a surface 510 of the rotor portion 500 facing the suction opening portion 100. The sucked air flows with heading an outer peripheral direction from the center of the rotational shaft 400 as the cross-sectional view in FIG. 3(a) showing and keeping a vector of a rotational direction as the top view in FIG. 3(a) showing when the surface 510 of the rotor portion 500 is rotating. Therefore, outside air is sucked through the suction opening portion 100 and the sucked air flows to the gap 300 facing the rotor portion 500 and then is discharged from the exhaust opening portion 200. As described above, when the motor 50 starts rotating, the air is sucked through the suction opening portion 100 and flows through the gap 300 and then is exhausted from the exhaust opening portion 200. In other words, air is sucked into the cover 10 through the suction opening portion 100 from outside by rotation of the rotor portion 500 and the sucked air flows out of the cover 10 through the exhaust opening portion 200 that is located apart from the suction opening portion 100 in the axial direction of the rotation shaft 400. To form this air flow is able to cool down the motor 50.

On the other hand, if the cover is absent, the air does not flow as described above. The air generated by the rotation of the motor 50 scattered around as shown in the top side view and the cross-sectional view in FIG. 3(b). Because of the cover 10, it is possible to guide the flow of air generated by the motor 50 in a specific direction in the embodiment 1.

The motor 50 generates heat during operation. The flow of air generated by the rotation of the rotor portion 500 can take cool outside air inside of the cover 10 through the suction opening portion 100 and exhaust air heated by the heat the motor 50 generates through the exhaust opening portion 200. Therefore, the motor 50 is able to be cool down effectively.

Note that, about the cover 10, a lib 14 may be provided on a surface 12 that is facing the surface 510 of the rotor portion 500 as shown in FIG. 1(b). The lib 14 is provided on a surface 12 in the side that is facing the rotor portion 500 in the first portion 10a and is shaped as a helix heading the suction opening portion 100 from the part where the first portion 10a and the second portion 10b are continuously put together. In other words, the lib 14 is formed radially from the suction opening portion 100 as a spiral. Therefore, a flow of air of the rotational direction shown in the top view in FIG. 3(a) and a flow of air of the outer peripheral direction of the rotation shaft 400 in the cross-sectional view in FIG. 3(a) are generated more effectively.

As described above, to comprising the motor and the motor cover makes it possible for the rotation of the motor to generate an air flow to cool down the motor without additional space for a fan or increasing cost.

According to the embodiment 1, it is possible to cool down the motor as keeping it from increasing cost or the size by adding a fan.

### Embodiment 2

An embodiment 2 will be described as referring to FIGS. 4, 5, 6, 7, and 8. Same reference numerals are put on same members in the embodiment 1. Note that, if a member comprises the same structure and same function as the embodiment 1, its description will be omitted.

### Image Forming Apparatus

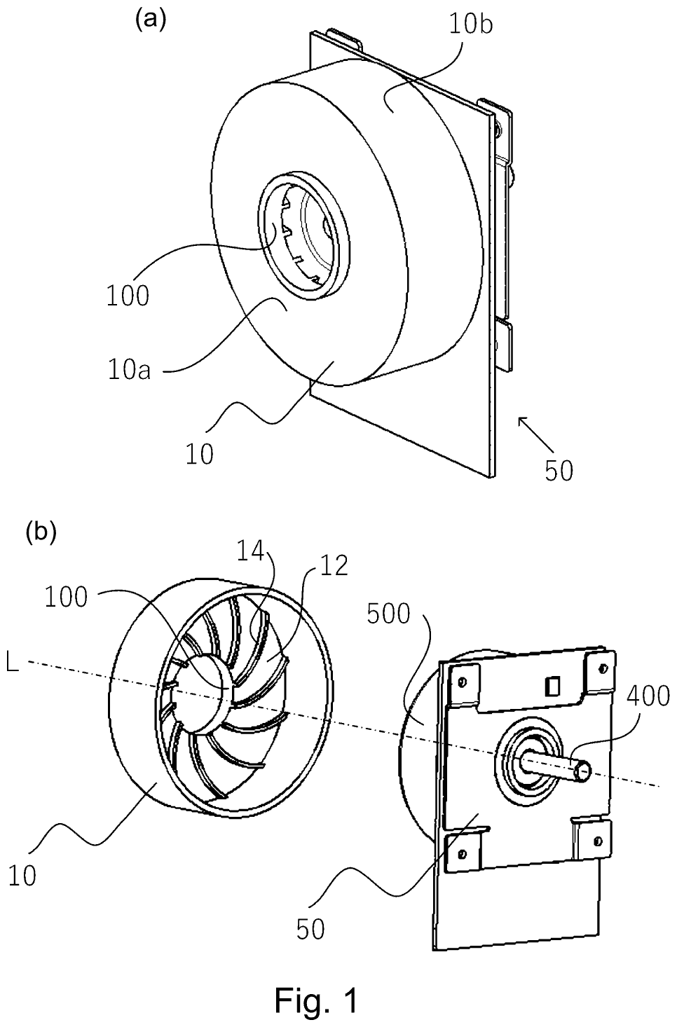

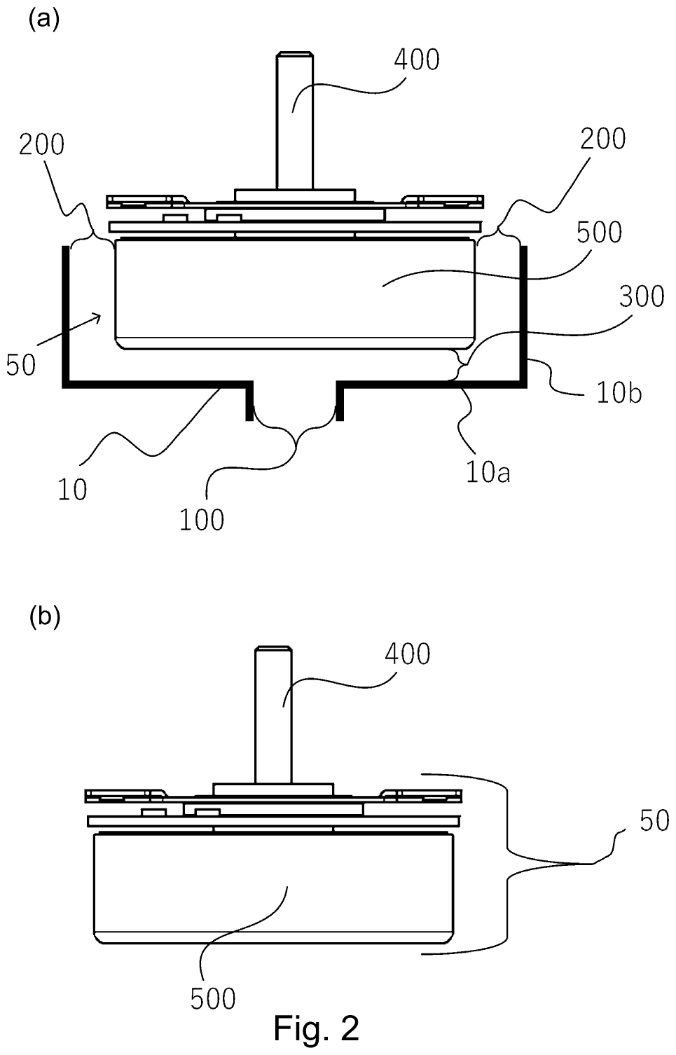

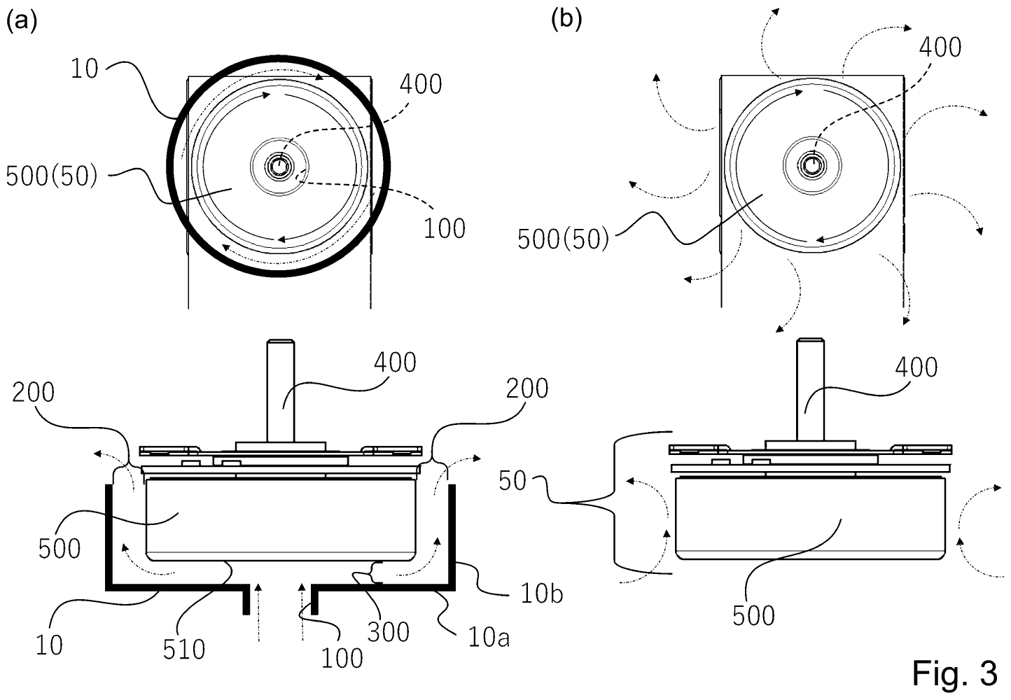

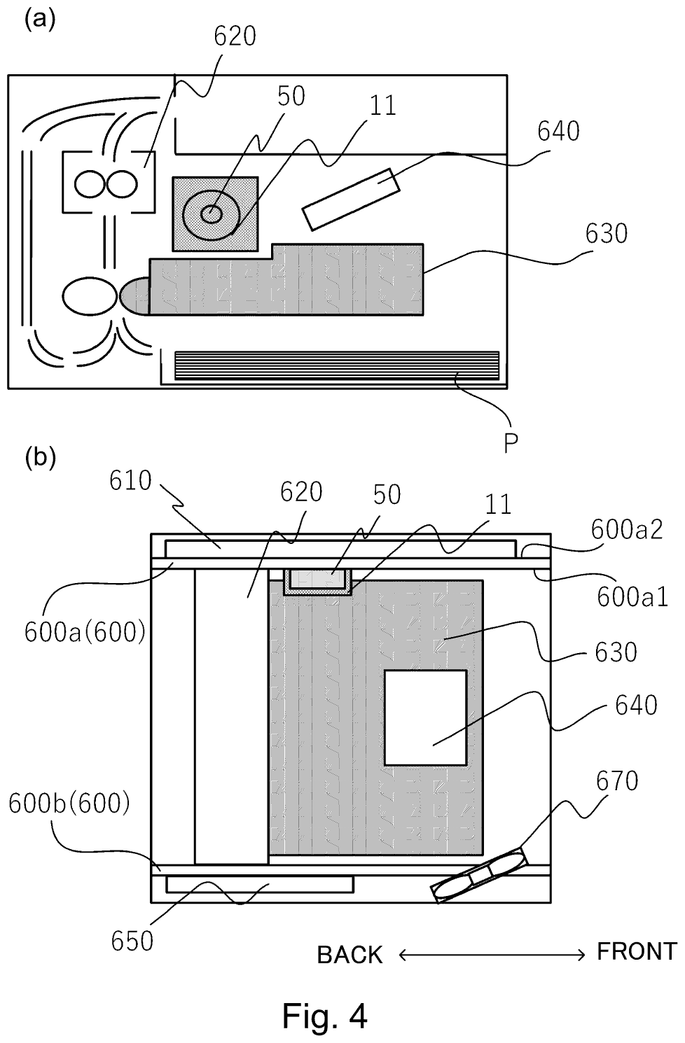

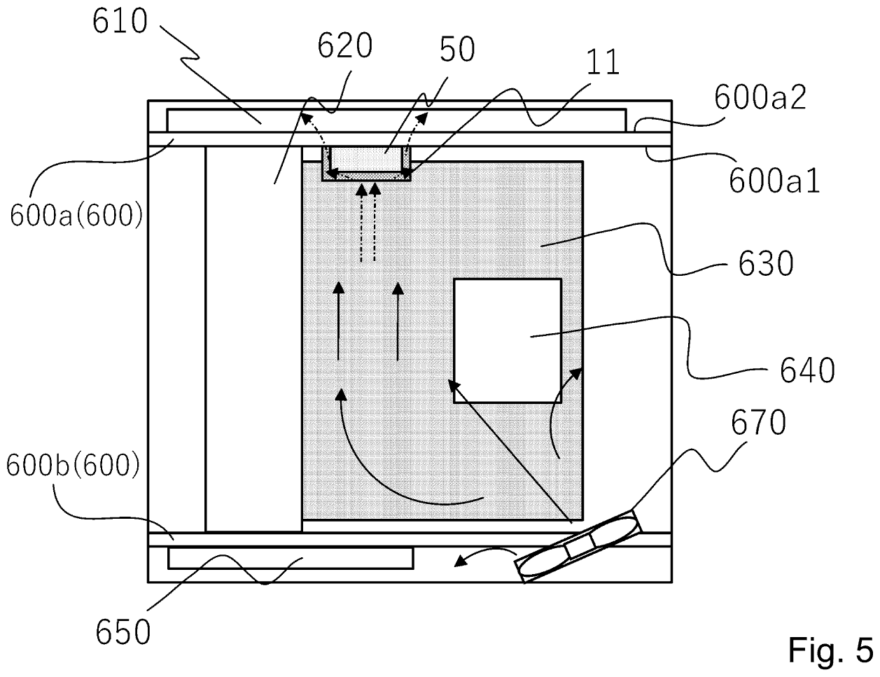

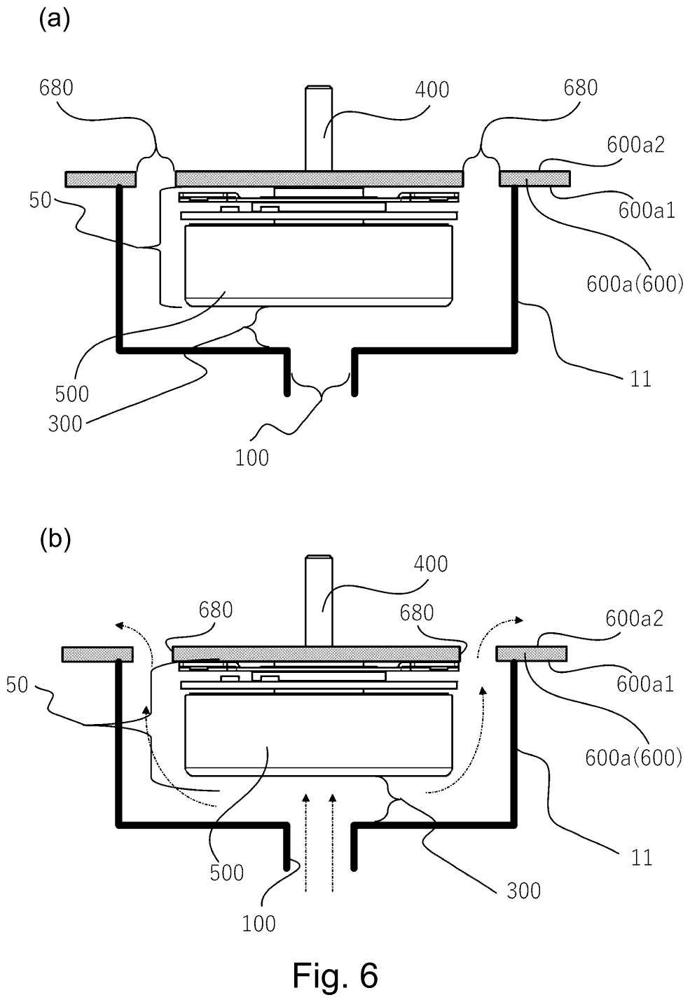

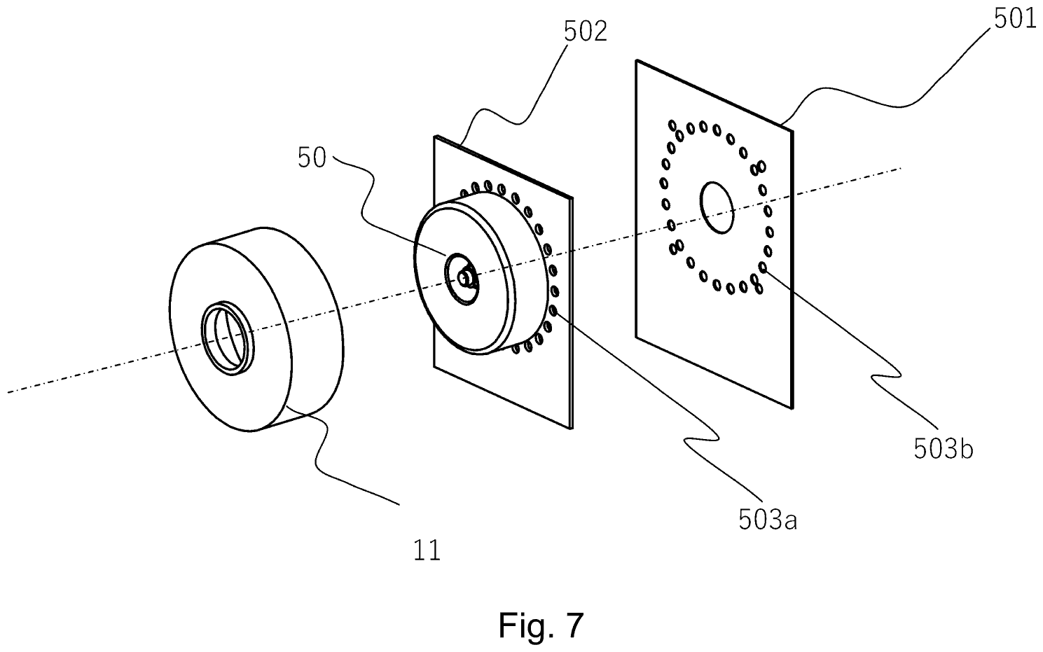

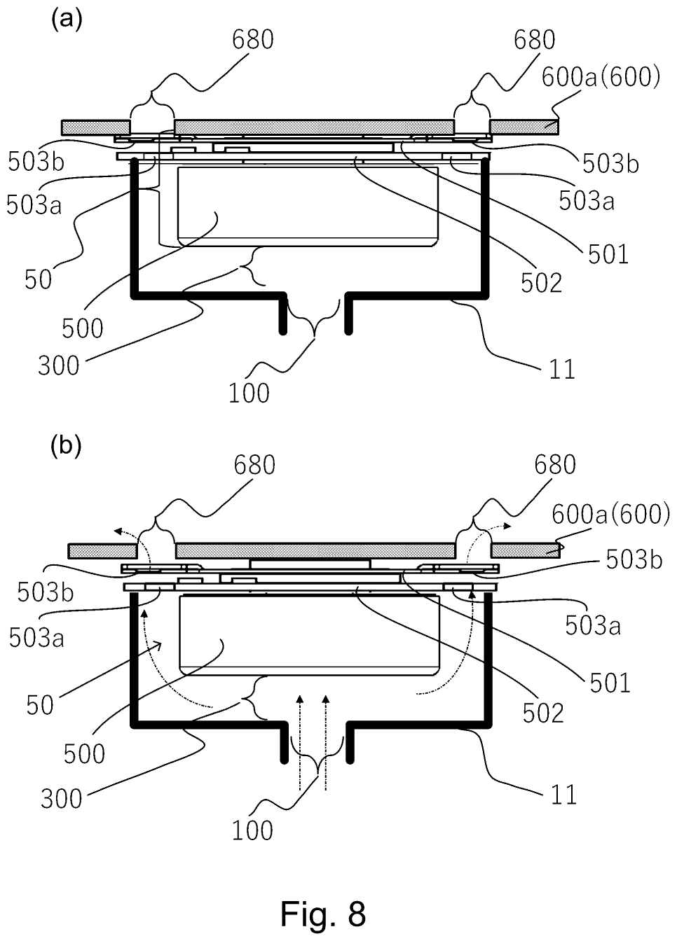

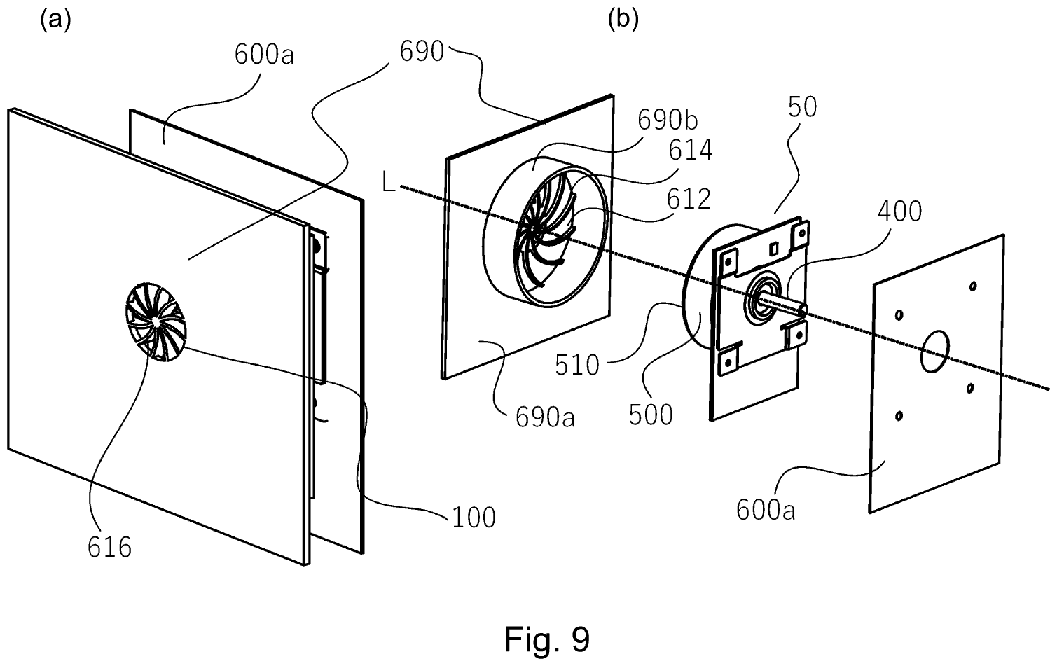

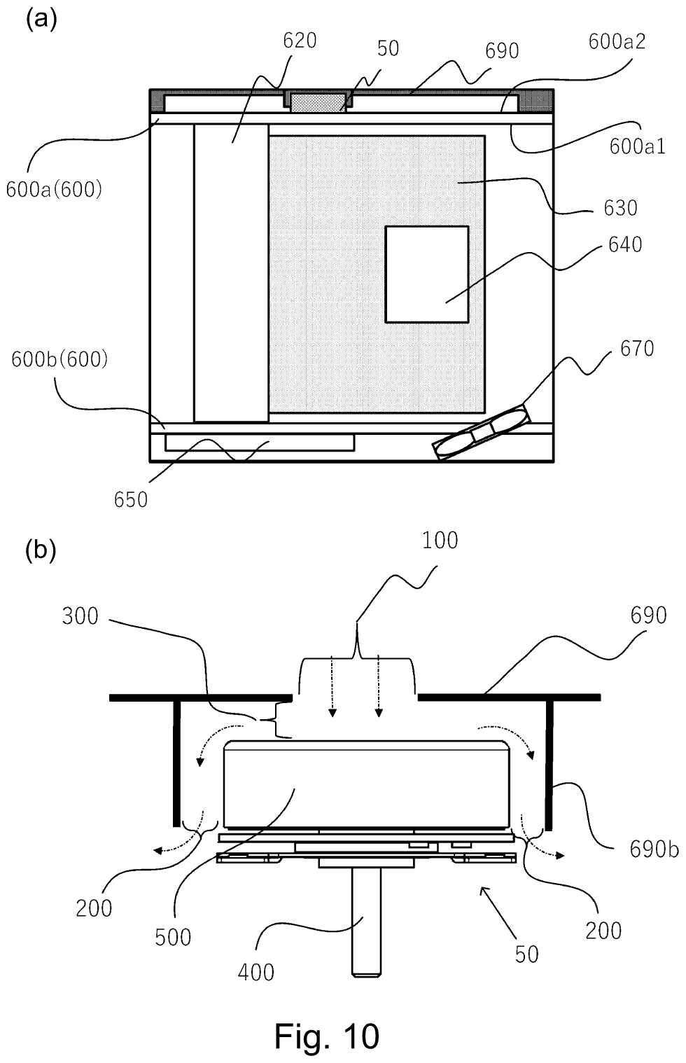

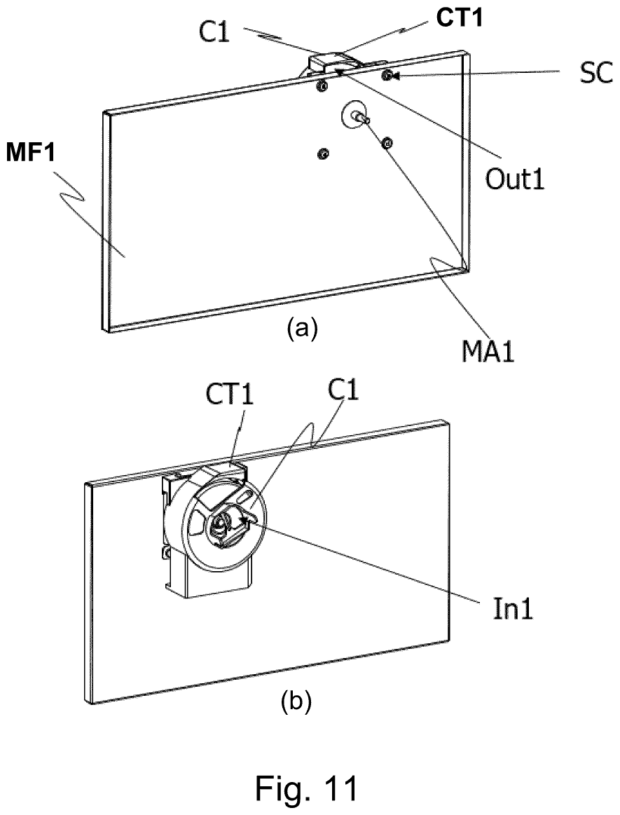

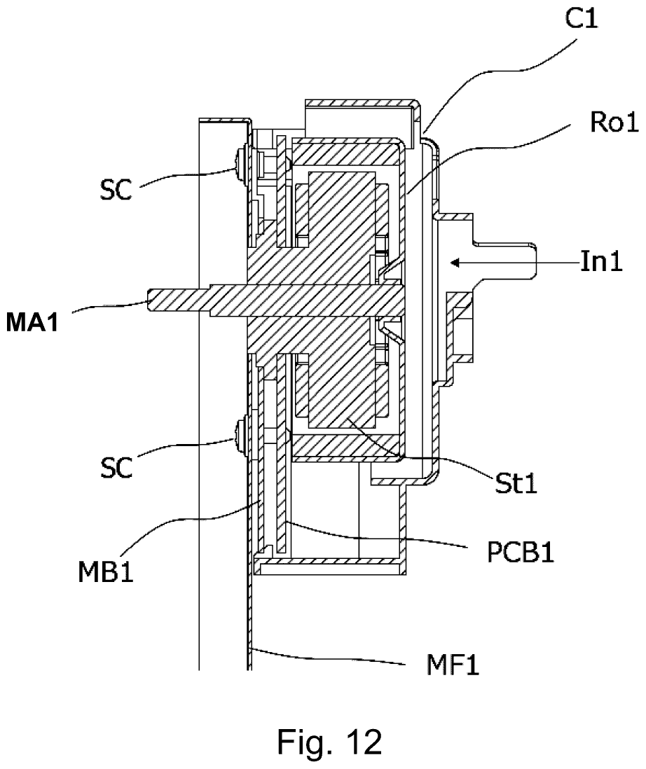

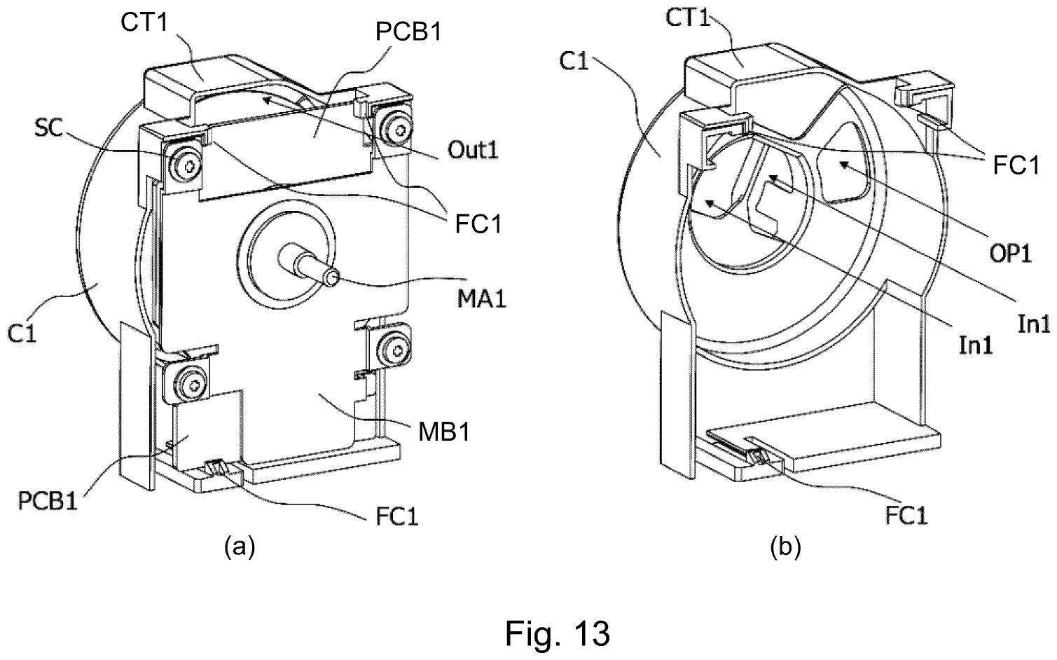

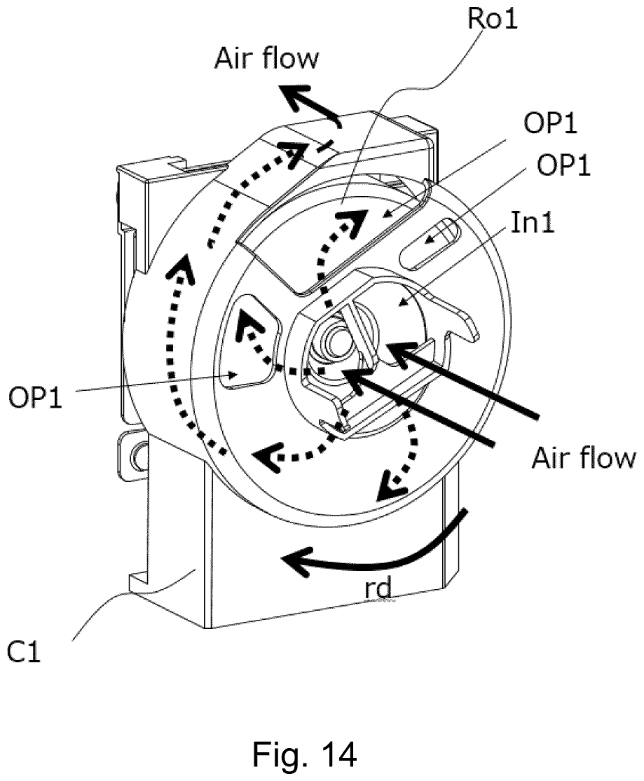

FIG. 4 is a drawing explaining a structure of an image forming apparatus in an embodiment 2. FIG. 4(a) is a cross-sectional view of the image forming apparatus seen from the side and FIG. 4(b) is a cross-sectional view seen from the top. FIG. 5 shows a flow of air sent from a fan 670 which is provided in the image forming apparatus. In FIG. 5, the flow of air sent from the fan 670 which is provided in the image forming apparatus is shown with an arrow with a solid line and the flow of air sucked and exhausted by a motor cover (hereinafter, referred to as a cover) 11 with a cooling function as a cover member is shown with an arrow with a dot-dash line. FIG. 6(a) is a cross-sectional view of a vicinity of a motor 50 in the embodiment 2 and FIG. 6(b) is showing a flow of air in FIG. 6(a) with an arrow with a dot-dash line. FIG. 7 is a perspective exploded view in a case that a motor substrate (a printing substrate provided with a motor drive circuit) 502 and a metallic motor sheet metal 501 are comprised of in the embodiment 2. A stator is fixed on the motor sheet metal 501. FIG. 8(a) is a cross-sectional view in the case that the motor substrate 502 and motor sheet metal 501 are included in the embodiment 2 and FIG. 8(b) is showing a flow of air in the case that the motor substrate 502 and motor sheet metal 501 are included.

An image forming apparatus is provided with a scanner 640 which is an exposing means forms an electrostatic latent image, a cartridge 630 which is a forming means forms a toner image on a recording sheet P based on the electrostatic latent image, and a fixing unit 620 which is a fixing means fixes the toner image. Also, the image forming apparatus is provided with a main body frame sheet metal 600b which is a first frame supporting one end of the fixing unit 620 and a main body frame sheet metal 600a which is a second frame supports another end of the fixing unit 620. The image forming apparatus is provided with a fan 670 as a cooling means located in the main body frame sheet metal 600b. Note that, the main body frame sheet metal 600a and 600b are referred to as a main body frame sheet metal 600 together and the image forming apparatus is provided with each member described above inside the main body frame sheet metal 600. The scanner 640 emits a light based on an image data. The cartridge 630 transfers a toner image formed by developing the electrostatic latent image, formed by the scanner 640, onto the recording sheet P. The fixing unit 620 fixes unfixed toner on the recording sheet P. The image forming apparatus is provided with the motor 50 and the fan 670.

The motor 50 is located between the fixing unit 620 and the cartridge 640/the scanner 640 inside of the main body frame sheet metal 600. Note that, the main body frame sheet metal 600 on the side that the motor 50 is located is the main body frame sheet metal 600a. The motor 50 and the cover 11 are located on the side of the main body frame sheet metal 600 that faces the main body frame sheet metal 600b. Here, the side that the motor 50 is located is referred to as a surface 600a1 and another side is referred to as a surface 600a2 of the main body frame sheet metal 600a. Note that, the cover 11 is a same structure as the cover 10 in the embodiment 1 and the description will be omitted.

The main body frame sheet metal 600a that the motor 50 is located on includes a vent opening portion 680 right under the motor 50 in the direction of a rotation shaft 400 and the cover 11 covers around the vent opening portion 680. In other words, the main body frame sheet metal 600a includes the vent opening portion 680 as a third opening portion connecting with an exhaust opening portion 200. The vent opening portion 680 may be provided with a ring shape as same as the exhaust opening portion 200, for example. Also, the vent opening portion 680 may be formed with several holes lining up as a ring shape. Between the cover 11 and a rotor portion 500, a gap 300 is provided and a suction opening portion 100 is provided on the direction of the rotation shaft 400 of the motor 50.

A driving unit 610 that drives the motor 50 is provided on the surface 600a2 which is and opposite side of the surface 600a1 of the main body frame sheet metal 600a that the motor 50 is located on. The main body frame sheet metal 600b which faces the main body frame sheet metal 600a where the driving unit 610 is located is provide a power source 650 and a fan 670. Note that, as FIG. 4 showing, when the side on which the recording sheet P is stored is a front side and the side on which the fixing unit 620 is provided is a back side, the fan 670 is located closer to the front than the power source 650.

### Case That the Motor Substrate and the Motor Sheet Metal is Used

A motor substrate 502 and a motor sheet metal 501 may be used when the motor 50 is installed with the main body frame sheet metal 600a. In this case, motor vent opening portions 503a and 503b are provided in a circumferential direction of a rotor portion 500 with each of the motor substrate 502 and the motor sheet metal 501. The motor substrate 502 includes the motor vent opening portion 503a which is a fourth opening portion and is installed with the motor 50. Also, the motor sheet metal 501 includes the motor vent opening portion 503b which is a fifth opening portion and is installed with the motor substrate 502. The motor vent opening portions 503a and 503b are provided as connecting with the exhaust opening portion 200 and the vent opening portion 680 when the motor 50, the motor substrate 502, the motor sheet metal 501 and the cover 11 are installed with the main body frame sheet metal 600a.

As shown in FIG. 7, the motor vent opening portions 503a and 503b are provided on outer side than the outside diameter of the motor 50 not to be blocked by the motor 50. The motor vent opening portions 503a and 503b are several holes lining up as a ring shape provided to pierce the motor substrate 502 or the motor sheet metal 501, as FIG. 7 showing for example. Even in this case, air is sucked from the fan 670 when the fan 670 and the motor 50 start operating. The air sucked from the fan 670 goes through the gap 300 from the suction opening portion 100 to the exhaust opening portion 200. And then, the air discharged from the exhaust opening portion 200 goes through the motor vent opening portions 503a and 503b and discharges outside from the vent opening portion 680 (FIG. 8(b)).

Note that, the shape and number of the holes of the motor vent opening portions 503a and 503b are not limited to. For example, the shape is not limited to a round but may be a shape that air can go through such as a slit formed by dividing a round or a round part formed like a mesh. Also, the motor vent opening portion 503a provided with the motor substrate 502 and the motor vent opening portion 503b provided with the motor sheet metal 501 may be located to overlap each other at least in a part of them as the air can go through. Further, several round holes are not only formed on one circumference as FIG. 7 shows, but round holes may be additionally formed on outer side of the circumference. Also, the motor vent opening portions 503a and 503b are formed inside the outer diameter of the cover 11 as FIG. 8(a) showing.

### Action

While the image forming apparatus is operating, temperature inside of a main body rises by a heat source such as the power source 650, the fixing unit 620, and the scanner 640. Therefore, the fan 670 operates and take air from outside to inside of the image forming apparatus during the operation of the image forming apparatus. In other words, the fan 670 sends cooling air to the cartridge 630, the scanner 640, and power source 650 as FIG. 5 showing with an arrow with a solid line. However, a pathway (hereinafter, referred as an air pathway) through which the cooling air flows tends to be narrow because of minimizing the size of the main body of the image forming apparatus and warm air tends to stagnate inside of the main body of the image forming apparatus. Also, cooling air hardly reaches the far component such as the motor 50.

On the other hand, a flow of air is generated between the suction opening portion 100 and a surface of the rotor portion 500 that faces the suction opening portion 100 by rotation of the rotor portion 500 of the motor 50 mounted with the cover 11 in the embodiment 2. Thus, the air flows in the direction from the center of the rotation shaft 400 to the outer peripheral direction as keeping the vector of the rotational direction by the surface of the rotor portion 500 that faces the suction opening portion 100 rotating as FIG. 3(a) described in the embodiment 1. Thus, the air is sucked from the suction opening portion 100 and discharged from the vent opening portion 680 which is located in the lower course of the air flow to outside the main body frame sheet metal 600a. In other words, cooling air sucked from the fan 670 cools down members such as the scanner 640, the fixing unit 620, and power source 650, and is further sucked in the gap 300 through the suction opening portion of the cover 11. And then, the air sucked from the suction opening portion 100 flows in the gap 300 and flows out of the main body frame sheet metal 600a through the vent opening portion 680.

The same effect is obtained when the motor vent opening portions 503a and 503b are provided in the motor substrate 502 and the motor sheet metal 501. A cooling air from the fan 670 and cools down members such as the scanner 640, the fixing unit 620, and power source 650, and is further sucked in the gap 300 through the suction opening portion of the cover 11. The air flows in the gap 300 and flows through the motor vent opening portion 503a of the motor substrate 502 and the motor vent opening portion 503b of the motor sheet metal 501, and flows out of the main body frame sheet metal 600a through the vent opening portion 680. As describe above, by that the fan 670 sucks air in the image forming apparatus and the cover 11 discharges air outside the image forming apparatus, the air stagnated inside the image forming apparatus is ventilated and a cooling air can reach far from the fan 670.

The structure described above makes it possible not only to generate the flow of the cooling air (the air flow) to cool down the motor 50 by rotation of the motor 50 but to promote ventilation inside the main body of the image forming apparatus. Thus, it is possible to cool down the motor 50 and to ventilate inside the image forming apparatus without additional space for a fan or increasing cost.

As described above, according to the embodiment 2, it is possible to cool down the motor as keeping it from increasing cost or the size by adding a fan.

### Embodiment 3

An embodiment 3 will be described as referring to FIG. 9 and FIG. 10. Same reference numerals are put on same members in the embodiment 1 and 2. Note that, if a member comprises the same structure and same function as the embodiment 1 and 2, its description will be omitted.

### Outer Cover

FIG. 9 shows a perspective view and perspective exploded view of a motor 50 and an outer cover 690 with cooling function as a cover member (hereinafter, referred as an outer cover) in an embodiment 3. Part (a) of FIG. 9 is a perspective view seen from a side with the outer cover 690 and Part (b) of FIG. 9 is a perspective exploded view seen from an opposite side of the side with the outer cover 690. Part (a) of FIG. 10 is a cross-sectional view seen from a top of an image forming apparatus mounted the outer cover 690 in the embodiment 3. Part (b) of FIG. 10 shows a flow of air around the motor 50 in the embodiment 3.

The image forming apparatus is provided with a main body frame sheet metal 600a which is provided with a motor 50. An outer cover 690 is a cover member covers with the main body frame sheet metal 600a. The outer cover 690 includes a first portion 690a which is orthogonal to the rotational axis direction of a rotor portion 500 and a suction opening portion 100 which is a first opening portion opens as including an imaginary line L extending a rotational shaft provided in the first portion 690a. The outer cover 690 includes a motor cover portion 690b which is a second portion sticking out of the first portion 690a and being parallel to the rotational axis direction.

In other words, the outer cover 690 includes the motor cover portion 690b and the suction opening portion 100, and the motor cover portion 690b covers around the rotor portion 500 of the motor 50. Therefore, a gap 300 is formed between the outer cover 690 and the rotor portion 500. When the outer cover 690 covers the main body frame sheet metal 600a, the first portion 690a and the motor cover portion 690b covers motor 50. And then, the gap 300 is formed both between the first portion 690a and the rotor portion 500 and between the motor cover portion 690b and the rotor portion 500. Therefore, an exhaust opening portion 200 which is a second opening portion continuing from the gap 300 is formed in the opposite side of the suction opening portion 100 in the rotational axis direction.

The outer cover 690 includes the suction opening portion 100 in the extending direction of a rotational shaft 400. As FIG. 9(b) showing, the outer cover 690 is provided with a lib 614 on a surface 612 which faces a surface 510 of the rotor portion 500. The 614 is formed as a spiral and radially from the suction opening portion 100. Also, the suction opening portion 100 is provided with a lib 616 which is continuing from a part of the lib 614 and connecting altogether at a center of the suction opening portion 100. Note that, the suction opening portion 100 of the cover 10 in the embodiment 1 may be provided with the structure such as the lib 616.

### Image Forming Apparatus

In the embodiment 3, the motor 50 is not located on a surface 600a1, but on a surface 600a2 of the main body frame sheet metal 600a. Also, the outer cover 690 is a cover which covers whole of the main body frame sheet metal 600a. The outer cover 690 is provided the suction opening portion 100 and the motor cover portion 690b in a place where the center of the suction opening portion 100 of the outer cover 690 meets the rotation shaft 400 of the motor 50 as the outer cover covering the main body frame sheet metal 600a. As described above, the motor 50 and the outer cover 690 is installed on the surface which is opposite side to the surface of the main body frame sheet metal 600a facing the main body frame sheet metal 600b in the embodiment 3. Note that, the main body frame sheet metal 600a may include a third opening portion (a vent opening portion 680) in the embodiment 3.

### Action

A flow of air is generated on a surface 510 of the rotor portion 500 which faces the suction opening portion 100 by rotation of the motor 50 mounted the outer cover 690 of the rotor portion 500. The air flows from the center of the rotation shaft 400 to the outer peripheral direction as keeping the vector of the rotational direction by the rotation of the surface 510 of the rotor portion 500 that faces the suction opening portion 100. Therefore, outside air is sucked from the suction opening portion 100 and flows through the gap 300 of the rotor portion 500 that faces the suction opening portion 100 into inside of the main body of the image forming apparatus. In other words, when the motor 50 starts to operate, the air is sucked through the suction opening portion 100 and flows through the gap 300 and then is exhausted from the exhaust opening portion 200. In the case that the third opening portion (the vent opening portion 680) is located on the main body frame sheet metal 600a, the air flows through the third opening portion and is sucked into a space where is formed by the main body frame sheet metal 600 i.e., inside the image forming apparatus.

While the image forming apparatus is operating, temperature inside of a main body rises. The flow of air generated by rotation of the rotor portion 500 makes it possible to bring outside air inside the main body of the image forming apparatus to cool down the motor 50 and the inside of the main body of the image forming apparatus. The structure of the outer cover 690 and the motor 50 as described above makes it possible to generate the flow of air to cool down the motor 50 by rotation of the motor 50 itself without additional space for a fan or increasing cost.

As described above, according to the embodiment 3, it is possible to cool down the motor as keeping it from increasing cost or the size by adding a fan.

### Embodiment 4

A structure of an embodiment 4 is shown in FIG. 11 to FIG. 14. FIG. 11(a) is a view of a main body frame MF1 of an image forming apparatus seen from outside of the image forming apparatus (from a side of an outer cover that is not in the figures) and FIG. 11(b) is a view of a surface that is an opposite side of the main body frame MF1. A motor is fixed onto the main body frame MF1 with a screw SC. A cover C1 is provided with a suction opening portion In1. Also, the cover C1 is provided with a protruding portion CT1 that protrudes in a radial direction of the cover C1 outer than a cylinder shape portion of the cover 1. This protruding portion can suppress that the main body frame MF1 shut off exhausted air from an exhaust opening portion Out1 even if the cover 1 overlaps on the main frame body MF1. Note that, an MA1 is a rotational shaft of the motor.

FIG. 12 is a cross-sectional view of an outer roto type motor covered with the cover C. FIG. 13, Part (a) is a perspective view of the motor removed the main body frame and FIG. 13, Part (b) is a perspective view of the cover C1. FIG. 14 is a view shows an air flow when a rotor Ro1 rotates. An arrow rd shows a rotational direction of the rotor Ro1.

A stator St1 is fixed on a motor sheet metal MB1 and a printing substrate PCB1 is installed with the stator St1. The motor sheet metal MB1 on which the stator St1 is installed is fixed onto the main body frame MF1 of the image forming apparatus with the screw SC. The printing substrate PCB1 is provided with a hole which the screw SC pierces. The rotor Ro1 and the rotational shaft MA1 that the rotor Ro1 is fixed on are rotatably installed with the stator St1.

The cover C1 includes three sets of hook portions FC1 and is installed with the printing substrate PCB1 by three hook portions FC1. The cover C1 is provided with two sets of the suction opening portions In1. The suction opening portion In1 is located in vicinity of the center of the cover C1 in the radial direction of the rotor Ro1. The cover C1 is provided with three openings OP1 besides those two sets of the suction opening portion In1. Three openings OP1 are provided as the cover C1 does not interfere with other structures around the cover C1 in the image forming apparatus and are not necessary to cool down the motor. However, when the suction opening portion In1 near the center of the radial direction and the exhaust opening portion Out1 are provided, an effect of cooling down the motor is obtained even though the openings OP1 presents. As shown in FIG. 14, though a part of the air flown in through the suction opening portions In1 leaks out of the cover C1 through the openings OP1, most of the air flown in flows toward the exhaust opening portion Out1 as arrows show in FIG. 14. To form this air flow, an area of the suction opening portions In1 is preferable to be 5% or more and 50% or less of an area of the rotor Ro1 when they are seen in the axial direction of the rotation shaft MA1 as same as the embodiment 1.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2022-205341 filed on Dec. 22, 2022, and 2023-178621 filed on Oct. 17, 2023, which are hereby incorporated by reference herein in their entirety.

What is claimed is:

1. An outer rotor type motor covered with a cover member, the motor comprising:
a motor substrate;
a stator portion provided on the motor substrate;
a rotor portion mounted with a rotational shaft and configured to rotate about the stator portion; and
a cover member provided on an outside of the rotor portion with respect to a radial direction of the rotor portion and an axial direction of the rotational shaft and arranged to be fixed,
wherein a first opening portion is formed on a central portion, in the radial direction, of a first portion of the cover member opposing a part on which the rotational shaft of the rotor portion is mounted in the axial direction. and wherein an air is sucked inside of the cover member from an outside of the cover member through the first opening portion by rotation of the rotor portion, and the air sucked is discharged to the outside of the cover member through a second opening portion formed on a position away from the first opening portion in the axial direction.

2. A motor according to claim 1, wherein the second opening portion is a space formed between the motor substrate and the cover member.

3. A motor according to claim 1, wherein the second opening portion is formed on the motor substrate.

4. A motor according to claim 1, wherein an end portion of the rotational shaft on a side of the first opening portion is positioned inside of the cover member with respect to the axial direction.

5. A motor according to claim 1, wherein as viewed in the axial direction, an area of the first opening portion is 5% or more and 50% or less of an area of the rotor portion.

6. A motor according to claim 1, wherein a helical rib toward the first opening portion is provided in an inner surface of the first portion of the cover member.

7. An image forming apparatus for forming a toner image on a recording material, the image forming apparatus comprising:
a main body frame;
a motor substrate;
a stator portion provided on the motor substrate;
a rotor portion mounted with a rotational shaft and configured to rotate about the stator portion; and
a cover member provided on an outside of the rotor portion with respect to a radial direction of the rotor portion and an axial direction of the rotational shaft and arranged to be fixed,
wherein the motor substrate is mounted on the main body frame,
wherein a first opening portion is formed on a central portion, in the radial direction, of a first portion of the cover member opposing a part on which the rotational shaft of the rotor portion is mounted in the axial direction. and
wherein an air is sucked inside of the cover member from an outside of the cover member through the first opening portion by rotation of the rotor portion, and the air sucked is discharged to the outside of the cover member through a second opening portion formed on a position away from the first opening portion in the axial direction.

8. An image forming apparatus according to claim 7, wherein the cover member is mounted on the main body frame and the second opening portion is an opening formed on the main body frame.

9. An image forming apparatus according to claim 7, wherein the second opening portion is a space formed between the motor substrate and the cover member.

10. An image forming apparatus according to claim 7, wherein the second opening portion is formed on the motor substrate.

11. An image forming apparatus according to claim 7, wherein an end portion of the rotational shaft on a side of the first opening portion is positioned inside of the cover member with respect to the axial direction.

12. An image forming apparatus according to claim 7, wherein as viewed in the axial direction, an area of the first opening portion is 5% or more and 50% or less of an area of the rotor portion.

13. An image forming apparatus according to claim 7, wherein a helical rib toward the first opening portion is provided in an inner surface of the first portion of the cover member.

14. An image forming apparatus according to claim 7, further comprising an outer cover of the image forming apparatus configured to cover the main body frame, wherein the outer cover forms the cover member.
